(19) United States
(12) Patent Application Publication
(10) Pub. No.: US 2002/0055871 A1
(43) Pub. Date: May 9, 2002

(54) Method and apparatus for interactive advertising

(76) Inventor: Thilo Gabler, Lake Havasu City, AZ (US)

Correspondence Address: CHRISTIE, PARKER & HALE, LLP, 350 WEST COLORADO BOULEVARD, SUITE 500, PASADENA, CA, 91105, US

(21) Appl. No.: 09/875,387

(22) Filed: Jun. 5, 2001

Related U.S. Application Data
(63) Continuation-in-part of application No. 09/707,603, filed on Nov. 7, 2000.

(51) Int. Cl. G06F 17/60

(52) U.S. Cl. 705/14

(57) ABSTRACT

A method and system for incentive based advertisement. Advertising viewers register with an advertising server. The advertising server collects viewer profile data from the advertising viewers. Advertisers describe to the advertising server a profile of an ideal advertising viewer and link advertising content to the profile. A viewer logs on to the system and receives advertising content selected to fit the viewer's profile. The viewer watches the advertising and receives an incentive in the form of an entry into a sweepstakes.

### CROSS-REFERENCE TO RELATED APPLICATION

The present application is a continuation-in-part of co-pending U.S. patent application Ser. No. 09/707,603, filed Nov. 7, 2000 which is expressly incorporated herein by reference as though fully set forth in full.

### BACKGROUND OF THE INVENTION

The present invention relates generally to delivering advertising and specifically to delivering advertising content to consumers linked to an incentive for viewing the advertising content.

The advent of the Internet has created an opportunity to target advertising down to the level of an individual consumer. The Internet makes this possible because the medium is composed of a global network of general purpose computers for both the display and the dissemination of advertising content. Both the content server and the client used by a consumer to access the content server can be programmed to collect information from each consumer accessing the content server. In response to being targeted at an individual level, technologically astute consumers have responded by avoiding content servers that collect personal information used in targeting advertisements.

Advertisers need a way to deliver targeted advertisements to technologically astute consumers who currently avoid content servers intending to collect consumer information for targeted advertisements. The present invention meets such a need by providing a tangible benefit in exchange for receiving targeted advertisements.

### SUMMARY OF THE INVENTION

In one aspect of the invention, a method is provided for incentive advertising. The method includes receiving a viewer address, sending advertisement content for display to the viewer using the viewer address, and recording the viewer address for awarding an advertising incentive.

In another aspect of the invention, a data processing system is adapted for incentive advertising. The data processing system includes a processor and a memory operably coupled to the processor. The memory includes program instructions including: receiving a desired viewer profile from an advertiser; linking the desired viewer profile to advertising content; receiving a viewer profile, the viewer profile including viewer identification, viewer advertising content viewing preferences, viewer language preference, viewer address, and viewer physical location; selecting advertising content to send to the viewer upon matching the viewer profile to the desired viewer profile; sending the advertisement content for display to the viewer; and recording the viewer address for entry into a game of chance.

The advantages offered by the present invention to advertisers include having a permission-based, one-on-one environment in which an existing television or radio commercial advertising content is streamed to a viewer whose profile corresponds directly with the advertiser's target audience in terms of gender, age, language, location and product preference. A further advantage is that no extra production cost is involved in producing the advertising content because existing television and radio commercials are used to create advertising content.

A further advantage is that an advertiser has the opportunity to couple advertising content with a direct link to the advertiser's own Web site. This allows a viewer to conclude a sale or acquire additional information about the products or services featured in the advertising content.

A further advantage of the present invention is that advertiser's receive a direct response from the viewer about the quality of the advertising content.

A further advantage of the present invention is that each viewing of advertising content is accounted for creating a low-cost, pay-per-view advertising format as opposed to the traditional “machine-gun” approach of television and radio commercials.

### BRIEF DESCRIPTION OF THE DRAWINGS

These and other features, aspects, and advantages of the present invention will become better understood with regard to the following description, appended claims, and accompanying drawings where:

FIG. 1 is a deployment diagram for an incentive based advertising system using the Internet;

FIG. 2 is an architecture diagram for a general purpose computer adapted for use as a sweepstakes server;

FIG. 3 is a sequence diagram of a viewer registration process according to the present invention;

FIG. 4 is a sequence diagram of an advertiser registration process according to the present invention;

FIG. 5 is a sequence diagram of a process of viewing a commercial and gaining a sweepstakes entry according to the present invention;

FIG. 6 is a sequence diagram of an advertiser data access process according to the present invention;

FIG. 7 is a process flow diagram of a winner selection process;

FIG. 8 is a sequence diagram of an embodiment of a winner selection process according to the present invention; and

APPENDIX A is a Web site specification according to the present invention.

### DETAILED DESCRIPTION

An incentive based advertising system provides a platform for streaming television and radio commercials to a micro-targeted and motivated viewing audience around the world. The advertiser specifies the profile of a consumer to whom the commercial is shown based on gender, age, language, location (country and zip/postal codes) and product preference. In one embodiment, the popular principle of a sweepstakes competition is used to entice viewers to view advertising content.

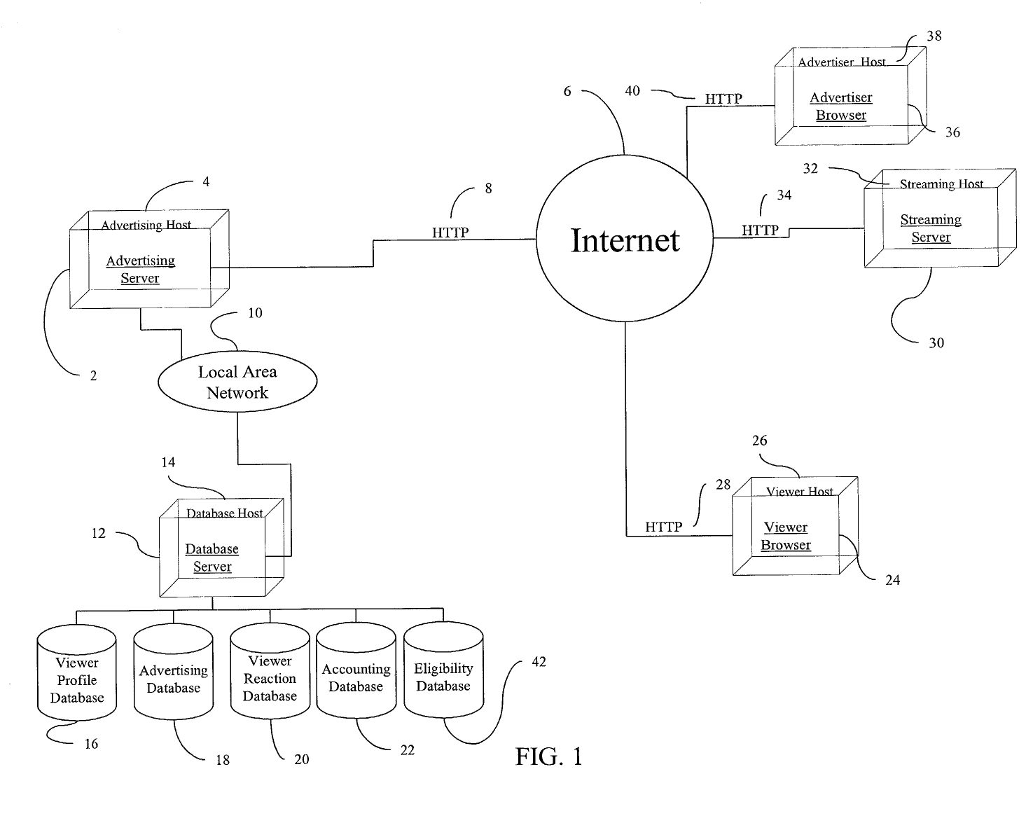

FIG. 1 is a deployment diagram for an incentive based advertising system using the Internet. Advertising server 2 is hosted by advertising host 4. The advertising server communicates to clients and other servers via Internet 6. The advertising server is operably coupled to the Internet via advertising communications link 8 adapted for communications using Hyper Text Transfer Protocol (HTTP). The advertising server coordinates the activities of the incentive base advertising system. The advertising server generates and serves documents written in Hyper Text Markup Language (HTML) implementing viewer applications for registration and viewing of advertising content. The specifications for the viewer applications are fully described in APPENDIX A. The advertising server also generates and serves documents written in HTML implementing advertiser applications for managing advertising content and retrieving viewing histories.

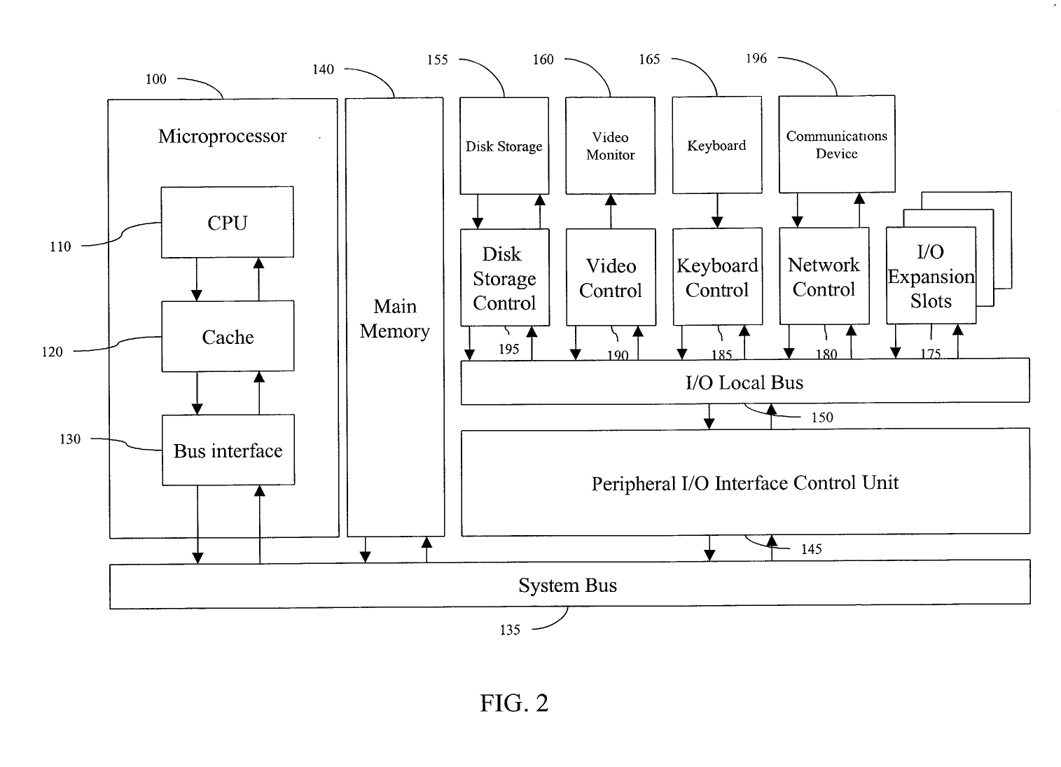

FIG. 2 is an architecture diagram for a general purpose computer adapted for use as an advertising host. Microprocessor 100, comprised of a Central Processing Unit (CPU) 110, memory cache 120, and bus interface 130, is operatively coupled via system bus 135 to main memory 140 and I/O control unit 145. The I/O interface control unit is operatively coupled via I/O local bus 150 to disk storage controller 195, video controller 190, keyboard controller 185, and communications device 180. The communications device is adapted to allow software objects hosted by the general purpose computer to communicate via a network with other software objects. The disk storage controller is operatively coupled to disk storage device 125. The video controller is operatively coupled to video monitor 160. The keyboard controller is operatively coupled to keyboard 165. The network controller is operatively coupled to communications device 196.

Computer program instructions implementing an advertising server according to the current invention are stored on the disk storage device until the microprocessor retrieves the computer program instructions and stores them in the main memory. The microprocessor then executes the computer program instructions stored in the main memory to implement the advertising server.

Referring again to FIG. 1, advertising server 2 is operably coupled to local area network (LAN) 10. Database server 12, hosted by database host 14 is operably coupled to the LAN. The advertising server communicates to the database server via the LAN. The database server provides services for querying and updating a plurality of databases used by the advertising server. Viewer profile database 16 contains viewer profiles of viewers using the system. Advertising database 18 contains profiles of advertising content available through the incentive based advertising system. Viewer reaction database 18 contains the reactions of viewers to advertising content. Accounting database 22 contains accounting information used to track viewership of the advertising content. Eligibility database 42 contains the viewer IDs of viewers eligible for an incentive selection. Viewers access the advertising server using viewer browser 24 hosted by viewer host 26. The viewer browser is operably coupled to Internet 6 via viewer communications link 28. The viewer communications link is adapted for transferring HTML document using HTTP. Advertisers access the advertising server using advertiser browser 36 hosted by advertiser host 38. The advertiser browser is operably coupled to the Internet via advertiser communications link 40 adapted for transferring HTML documents using HTTP. Streaming server 30 is hosted by streaming host 32. The streaming server is operably coupled to the Internet via streaming communications link 34 adapted for transferring streaming media content from the streaming server to the viewer browser. The streaming server provides the actual advertising content to a viewer as specified by the advertising server.

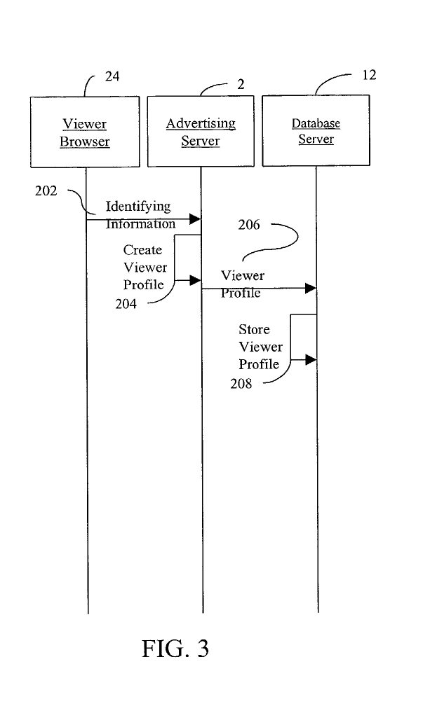

FIG. 3 is a sequence diagram of a viewer registration process according to the present invention. A viewer uses viewer browser 24 to send identifying information 202 to advertising server 2. The viewer identification information includes an indication of the viewer's physical location, such as a zipcode, an indication of the types of products the viewer is interested in, the age of the viewer, the preferred language of the viewer, gender of the viewer, and the bandwidth of the viewer's communications link. The advertising server creates 204 a viewer profile 206 based on the identifying information sent by the viewer browser and sends the viewer profile to database server 12. The database server stores 208 the viewer profile in viewer profile database 16 (FIG. 1).

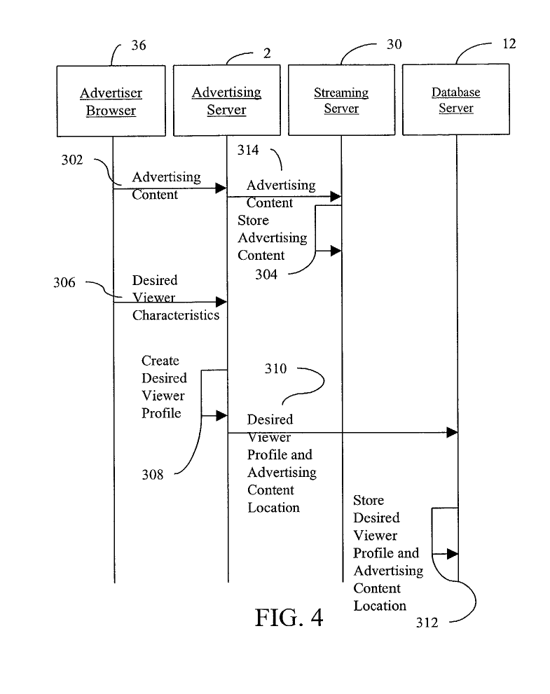

FIG. 4 is a sequence diagram of an advertiser registration process according to the present invention. An advertiser uses advertising browser 36 to send advertising content 302 to advertising server 2. In one embodiment, the advertising content is in the form of a video commercial suitable for broadcast on a cable network or other video broadcast medium. In another embodiment, the advertising content is in the form of an audio commercial suitable for replay over a radio or other audio broadcast medium. The advertising server forwards the advertising content 314 to streaming server 30. Alternatively, the advertiser sends the advertising content directly to the streaming server and sends a Uniform Resource Locator (URL) pointing to the advertising content to the advertising server. In one embodiment, advertising content includes separate data sets encoded in different formats. The different formats are used to serve advertising content appropriate to the bandwidth of viewer communications link 28 (FIG. 1). For example, if a viewer is connected using a viewer communications link with a limited bandwidth, then a highly compressed version of the advertising content is provided. With higher bandwidths, higher quality and less compressed versions of the advertising content may be provided. Alternatively, the streaming server may create compressed versions on demand of the advertising content from a single stored version of the advertising content. The streaming server stores 304 the advertising content for the advertiser and makes the advertising content available to clients via Internet 6 (FIG. 1).

Alternatively, the advertising host 4 (FIG. 1) hosts the streaming server.

The advertiser uses the advertiser browser to send desired viewer characteristics to advertising server 2. The advertising server creates 308 a desired viewer profile 310 and sends the desired viewer profile and advertising content location to database server 12. The desired viewer profile includes the characteristics of an ideal viewer as envisioned by the advertiser. The desired viewer profile includes an indication of an ideal viewer's physical location, such as a zipcode, an indication of the types of products an ideal viewer is interested in, the age range of an ideal viewer, the preferred language of an ideal viewer, and the gender of an ideal viewer. The database server stores 312 the desired viewer profile and advertising content location in advertising database 18 (FIG. 1).

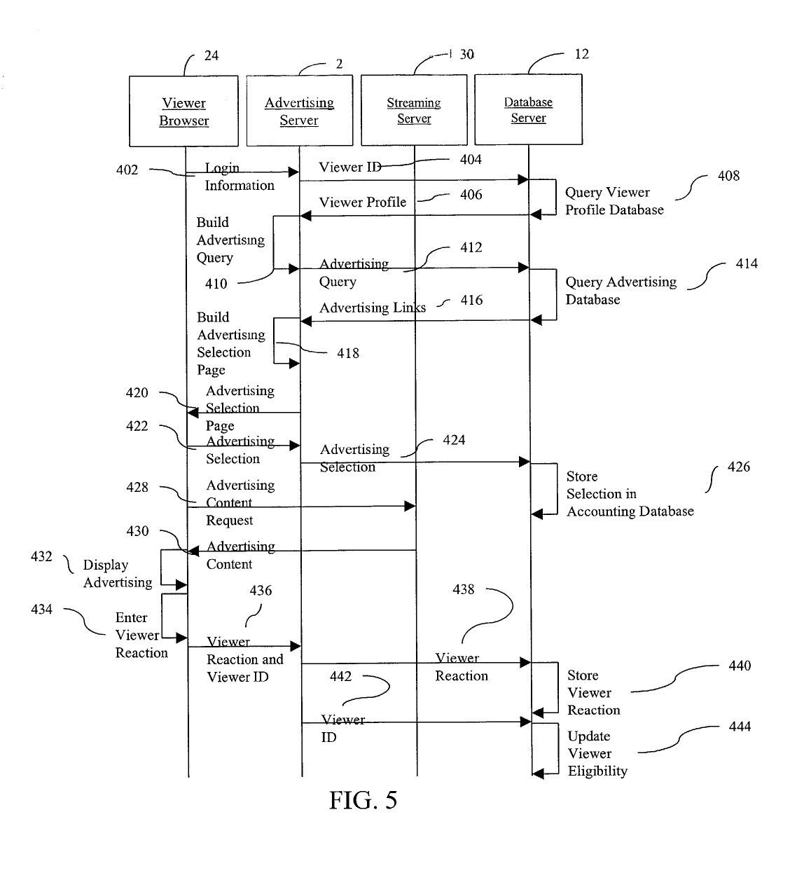

FIG. 5 is a sequence diagram of a process of viewing advertising content and gaining an opportunity to win an incentive according to the present invention. A viewer uses viewer browser 24 to send login information 402 to advertising server 2. The advertising server uses the login information to identify the viewer and sends viewer ID 404 to the database server as a viewer profile query. The database server uses the viewer profile query to query 408 viewer profile database 16 to get a viewer profile 406 for the viewer. The advertising server uses the viewer profile to build 410 advertising query 412 used to obtain links to advertising content on streaming server 30 (FIG. 1). The advertising server sends the advertising query to the database server. The database server queries 414 advertising database 18 for locations to advertising content intended by an advertiser for an ideal viewer matching the viewer profile of the viewer. The database server sends back advertising links 416 to the advertising server. The advertising server builds 418 advertising selection Web page 420 for use by the viewer in selecting advertising content for viewing. In one embodiment, the amount of advertising content viewable by a viewer in one day is restricted. In another embodiment, the order of the advertising content links included in the advertising selection Web page is determined by advertisers paying premiums to be included in the most advantageous locations in the advertising selection Web page. The advertising selection Web page is sent to the viewer browser and the viewer selects advertising content to view. Advertisement selection 422 is sent to the advertising server and advertising selection 424 is sent to the database server by the advertising server. The database server stores 426 the advertising selection in accounting database 22 (FIG. 1). Advertising request 428 is sent to streaming server 30 and advertising content 430 is sent in response. The viewer browser displays 432 the advertising content. Alternatively, the viewer browser buffers the advertising content in a local datastore on viewer host 26 (FIG. 1). This allows a viewer to continue using the viewer host for other tasks while the advertising content is being downloaded from the streaming server. At the end of the display, the viewer enters 434 the viewer's reaction 436 to the advertising content. The viewer's reaction is sent to the advertising server and the advertising server sends 438 the viewer reaction to the database server. The database server stores 440 the viewer reaction in viewer reaction database 20 (FIG. 1). The advertising server sends the viewer's viewer ID 442 to the database server and the database server stores 444 the viewer ID in eligibility database 42 (FIG. 1). Entry of the viewer's viewer ID in the eligibility database makes the viewer eligibly for selection of an incentive award.

In one embodiment, the viewer is presented with a hyperlink to an advertiser's Web site where the viewer may find out more information about or purchase the advertiser's products.

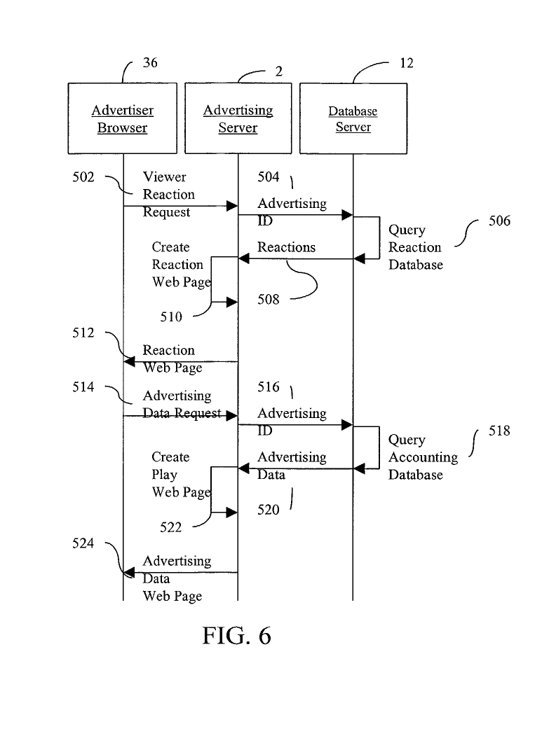

FIG. 6 is a sequence diagram of an advertiser data access process according to the present invention. An advertiser uses advertising browser 36 to send viewer reaction request 502 including an advertising content ID to advertising server 2. The advertising server uses the advertisement ID to create advertising ID query 504 sent to database server 12. The database server uses the advertising ID query to query viewer reaction database 20 for viewer reactions in response to advertising content specified by the advertising content ID. The viewer reactions 508 are sent to the advertising server. The advertising server creates 510 viewer reaction Web page 512 and sends the viewer reaction Web page to the advertising browser.

An advertiser uses the advertising browser to send advertising data request 514 including advertising content ID 516 to the advertising server. The advertising server sends the advertisement ID in the form of a query to the database server and the database server queries the accounting database for advertising data 520 statistics about the number of times the advertising content has been served to a viewer. The advertising data is sent to the advertising server where the advertising server creates 522 advertising data Web page 524 using the advertising data. The advertising data Web page is sent to the advertising browser for display to the advertiser.

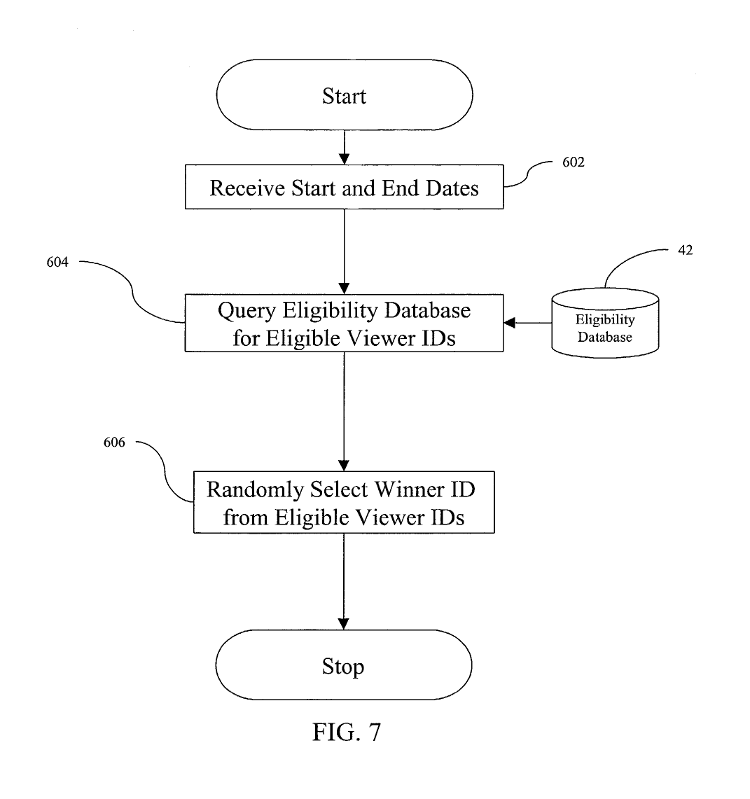

FIG. 7 is a process flow diagram of a winner selection process used by advertising server 2 (FIG. 1) to select a viewer to receive an incentive from a pool of eligible viewers. The advertising server receives 602 a start and end date from an advertising server administrator. The advertising server uses the start and end dates to query 604 eligibility database 42 for viewer IDs of viewers who viewed advertising content and responded to viewer reaction queries during the dates specified by the start and stop dates. The advertising server then randomly selects 606 a viewer to receive an incentive from the viewer IDs.

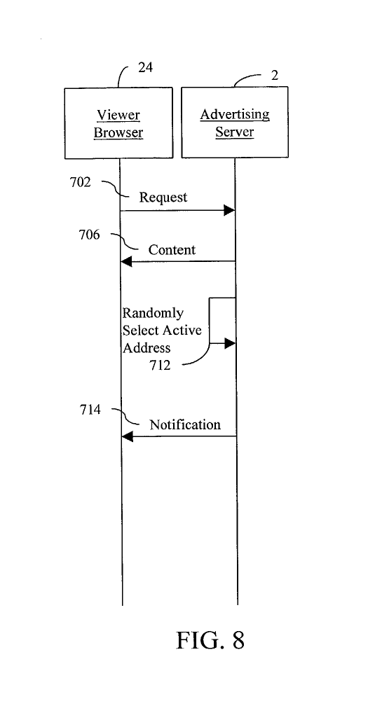

FIG. 8 is an exemplary embodiment of a method of providing viewer incentives according to the present invention without requiring the collection of viewer information. A viewer uses a viewer browser 24 to send a request to an advertising server 2 for advertising content. The request includes the viewer browser's host's IP address enabling the advertising server to send the requested content 706 to the viewer browser. The advertising server maintains a table of active addresses including the viewer browser's host's IP address. A viewer browser's host's IP address is stored for each viewer browser accessing the advertising server at any given point in time. The advertising server selects a viewer browser's host's IP address at random from the table of active addresses in order to award an incentive to a viewer. The advertising server sends a notification 714 to the viewer browser associated with the selected active address. The notification includes information on how the viewer is to collect the awarded incentive.

The preceding description has been presented with reference to specific embodiments of the invention shown in the drawings. Workers skilled in the art and technology to which this invention pertains will appreciate that alteration and changes in the described processes and structures can be practiced without departing from the spirit, principles and scope of this invention.

Accordingly, although this invention has been described in certain specific embodiments, many additional modifications and variations would be apparent to those skilled in the art. It is therefore to be understood that this invention may be practiced otherwise than as specifically described. Thus, the present embodiments of the invention should be considered in all respects as illustrative and not restrictive, the scope of the invention to be determined by the claims supported by this application and their equivalents rather than the foregoing description.

[image]

[image]

[image]

[image]

[image]

[image]

[image]

[image]

[image]

[image]

What is claimed is:

1. A method for incentive advertising, comprising:
receiving a viewer address;
sending advertisement content for display to the viewer; and
recording the viewer address for awarding an advertising incentive.

2. The method of claim 1, wherein the advertising incentive is an entry into a game of chance.

3. The method of claim 1, further comprising receiving a viewer profile, the viewer profile including a viewer identification.

4. The method of claim 3, wherein the viewer profile further includes advertising content viewing preferences of the viewer, the method further comprising selecting the advertising content based on the advertising content viewing preferences of the viewer.

5. The method of claim 3, wherein the viewer profile further includes a physical location of the viewer, the method further comprising selecting the advertising content based on the physical location of the viewer.

6. The method of claim 3, wherein the viewer profile further includes a language preference, the method further comprising selecting the advertising content based on the language preference of the viewer.

7. The method of claim 3, the method further comprising:
receiving a desired viewer profile from an advertiser;
linking the desired viewer profile to a particular advertising content; and
selecting the particular advertising content to send to the viewer upon matching the viewer profile to the desired viewer profile.

8. A method for incentive advertising, comprising:
sending a viewer address;
requesting advertising content;
displaying the advertising content; and
receiving an advertising incentive based on the viewer address.

9. The method of claim 8, wherein the advertising incentive is a notification that the viewer has won a game of chance.

10. The method of claim 9, further comprising sending a viewer profile, the viewer profile including a viewer identification.

11. The method of claim 10, wherein the viewer profile further includes advertising content viewing preferences of the viewer, the method further comprising requesting the advertising content based on the advertising content viewing preferences of the viewer.

12. The method of claim 10, wherein the viewer profile further includes a physical location of the viewer, the method further comprising requesting the advertising content based on the physical location of the viewer.

13. The method of claim 10, wherein the viewer profile further includes a language preference, the method further comprising requesting the advertising content based on the language preference of the viewer.

14. A data processing system adapted for incentive advertising, comprising:
a processor; and
a memory operably coupled to the processor and having program instructions stored therein, the processor being operable to execute the program instructions, the program instructions including:
receiving a viewer address;
sending advertisement content for display to the viewer; and
recording the viewer address for awarding an advertising incentive.

15. The data processing system of claim 14, wherein the advertising incentive is an entry into a game of chance.

16. The data processing system of claim 14, the program instructions further including receiving a viewer profile, the viewer profile including a viewer identification.

17. The data processing system of claim 16, wherein the viewer profile further includes advertising content viewing preferences of the viewer, the program instructions further including selecting the advertising content based on the advertising content viewing preferences of the viewer.

18. The data processing system of claim 16, wherein the viewer profile further includes a physical location of the viewer, the program instructions further including selecting the advertising content based on the physical location of the viewer.

19. The data processing system of claim 16, wherein the viewer profile further includes a language preference, the program instructions further including selecting the advertising content based on the language preference of the viewer.

20. The data processing system of claim 16, the program instructions further including:
receiving a desired viewer profile from an advertiser;
linking the desired viewer profile to a particular advertising content; and
selecting the particular advertising content to send to the viewer upon matching the viewer profile to the desired viewer profile.

21. A data processing system adapted for incentive advertising, comprising:
a processor; and
a memory operably coupled to the processor and having program instructions stored therein, the processor being operable to execute the program instructions, the program instructions including:
receiving a desired viewer profile from an advertiser;
linking the desired viewer profile to advertising content;
receiving a viewer profile, the viewer profile including viewer identification, viewer advertising content viewing preferences, viewer language preference, viewer address, and viewer physical location;
selecting advertising content to send to the viewer upon matching the viewer profile to the desired viewer profile;
sending the advertisement content for display to the viewer; and
recording the viewer address for entry into a game of chance.
